(19) United States
(12) Patent Application Publication
(10) Pub. No.: US 2007/0097454 A1
(43) Pub. Date: May 3, 2007

(54) Scanning module, image reading apparatus using the same, and maintenance method of the scanning module

(75) Inventor: Won-taek Kim, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/585,251

(22) Filed: Oct. 24, 2006

(30) Foreign Application Priority Data
Nov. 1, 2005 (KR) 2005-103787

(51) Int. Cl. H04N 1/04

(52) U.S. Cl. 358/474

(57) ABSTRACT

A scanning module including a light source to project light onto a document to be read, a lens unit to focus an optical signal read from the document being illuminated by the projected light, a plurality of mirrors to form an optical path from the light source to the lens unit, an image sensor to convert the optical signal focused by the lens unit into an electrical signal, a frame to house the light source, the lens unit, the mirrors, and the image sensor, and a fan to circulate air inside the frame.

### CROSS-REFERENCE TO RELATED PATENT APPLICATION

This application claims the benefit of Korean Application No. 2005-103787, filed Nov. 1, 2005, in the Korean Intellectual Property Office, the disclosure of which is incorporated herein in its entirety by reference.

### BACKGROUND OF THE INVENTION

1. Field of the Invention

Aspects of the present invention relate to a scanning module, an image reading apparatus using the scanning module, and a maintenance method of the scanning module, and, more particularly, to an integration type scanning module in which a light source, a mirror, a lens unit, and an image sensor are provided to read an image from a document, and an image reading apparatus using the scanning module and a maintenance method of the scanning module.

2. Description of the Related Art

A conventional image reading apparatus includes a scanning module that reads an image from a document by scanning the document with light to obtain an optical signal. The scanning module then converts the obtained optical signal into an electrical signal. Examples of such conventional image reading apparatuses include scanners, facsimiles, and multi-function apparatuses.

In conventional image reading apparatuses, the operation of reading an image from a document requires that either the scanning module or the document needs to be moved relative to the other. An image reading apparatus with a movable scanning module is called a flat-bed type image reading apparatus. On the contrary, an image reading apparatus configured to move a document is called a sheet-feed type image reading apparatus. The flat-bed type image reading apparatus and the sheet-feed type image reading apparatus may be combined by adding an auto document feeder (ADF) to the flat-bed type image reading apparatus.

A conventional image reading apparatus further includes a flat glass panel, on which documents are placed, with the scanning module being disposed underneath the flat glass panel to read the documents. The scanning module includes a light scanning unit to project light to a document, an image sensor unit to convert an optical signal obtained by scanning the document into an electrical signal, and a light reflecting unit to reflect light reflected from the document to the image sensor unit.

The light scanning unit includes a light source to project light to a document from an underside of the flat glass panel. The light source may be a halogen lamp that has a predetermined length in a main scanning direction of the document which is capable of projecting light across the main scanning direction at one time.

The image sensor unit includes an image sensor such as a charge-coupled device (CCD) sensor or a contact image sensor (CIS) sensor, a control board to control the operation of the image sensor, and a lens unit to focus optical signals onto the image sensor.

The light reflecting unit forms an optical path from the light source of the light scanning unit to the lens unit of the image sensor unit. The light reflecting unit includes a plurality of mirrors to reflect optical signals reflected from the document to the lens unit.

In conventional image reading apparatuses there are generally two types of scanning modules: an integration type scanning module and a separation type scanning module. The integration type scanning module includes a light scanning unit, an image sensor unit, and a light reflecting unit that are assembled into an enclosing frame together, and the frame, the light scanning unit, and the image sensor unit are moved together to read an image from a document. The separation type scanning module includes a light scanning unit, an image sensor unit, and a light reflecting unit that are separated to reduce the mass of inertia of the scanning module. The image sensor unit is fixed to a main body of an image reading apparatus. The light scanning unit and the light reflecting unit read an image from a document while they are moved in a subsidiary scanning direction at different speeds to keep the total length of an optical path constant.

Over the lifetime of the conventional image reading apparatuses, foreign substances tend to accumulate in the scanning module. As a result, components, such as the mirrors and the lens unit, are contaminated, with the image sensor considering the foreign substances as being image data. A combination of the foreign substances and movement of the scanning module results in an error data output in the form of a black line.

Particularly, in the integration type scanning module, in which the light scanning unit, the image sensor unit, and the light reflecting unit are assembled together, the foreign substances may be eliminated by a cleaning of the inside of the scanning module using, for example, an air gun only after disassembling the frame. However, since it is difficult for a user to perform such cleaning, professional cleaning services are required. Thus, maintenance cost and time are increased. However, if the foreign substances are not removed promptly and eventually become caked on the inside of the scanning module, removal of the caked foreign substances may become impossible.

Moreover, in the separation type scanning module having the light scanning unit, the image sensor unit, and the light reflecting unit that are separately installed, foreign substances may be easily removed by blowing air because components such as the mirrors and the lens unit are exposed to an exterior of the image reading apparatus. Thus, the integration type scanning module usually requires a much more complicated foreign substance eliminating unit and maintenance time and cost than the separation type scanning module.

Meanwhile, if the light source is turned on for a long time, the inside temperature of the scanning module increases. For example, various mechanisms making up the scanning module are formed of synthetic resin or the like, and the mirrors and lens unit are installed at a predetermined position and angle. Therefore, if the inside temperature of the scanning module increases, the mechanisms may be deformed, and the mirrors and the lens unit may deviate from the predetermined position and angle. This disturbs the focusing of the optical signal on a precise position of the image sensor, causing image reading errors.

### SUMMARY OF THE INVENTION

Aspects of the present invention provide a scanning module preventing image reading errors caused by build-up of foreign substances and high temperature, an image reading apparatus using the scanning module, and a method of maintaining the scanning module.

According to an aspect of the present invention, there is provided a scanning module comprising a light source to project light onto a document to be read, a lens unit to focus an optical signal read from the document; a plurality of mirrors to form an optical path from the light source to the lens unit, an image sensor to convert the optical signal focused by the lens unit into an electrical signal, a frame to house the light source, the lens unit, the mirrors, and the image sensor, and a fan to circulate air inside the frame.

According to another aspect of the present invention, there is provided an image reading apparatus in which a scanning module reads an image from a document while moving in a subsidiary scanning direction thereof, the scanning module comprising a light source to project light onto a document to be read, a lens unit to focus an optical signal read from the document, a plurality of mirrors to form an optical path from the light source to the lens unit, an image sensor to convert the optical signal focused by the lens unit into an electrical signal, a frame to house the light source, the lens unit, the mirrors, and the image sensor, and a fan circulating air inside the frame.

According to a further another aspect of the present invention, there is provided a maintenance method of a scanning module provided with a frame and a light source, a lens unit, a mirror, and an image sensor that are mounted in the frame, the scanning module reading an image from a document while moving in a subsidiary scanning direction, the maintenance method comprising circulating air inside the frame to remove foreign substances attached to at least one of the light source, the lens unit, the mirror, and the image sensor and/or to control a temperature of an inside of the frame.

Additional and/or other aspects and advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a perspective view of an image reading apparatus having a scanning module installed therein;

FIG. 2 is a perspective view of the scanning module and a driving module according to an embodiment of the present invention;

FIG. 3 is a side-sectional view of the scanning module of FIG. 2; and

FIG. 4 is a cross-sectional perspective view taken along a line A-A′ of FIG. 3.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

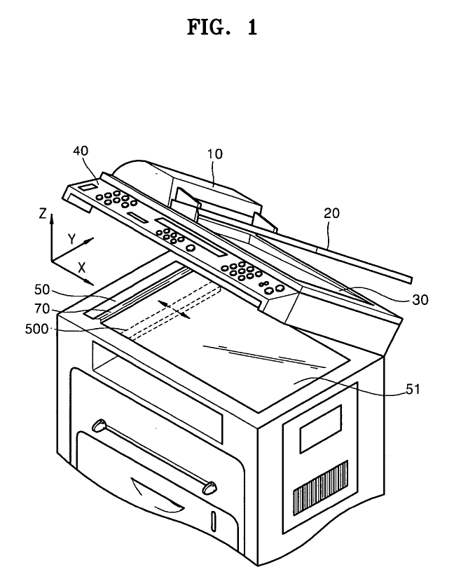

FIG. 1 is a perspective view of an image reading apparatus having a scanning module installed therein. As shown in FIG. 1, the image reading apparatus includes first and second flat glass panels 50 and 51, an auto document feeder (ADF) 10, and a scanning module 500. The X-axis denotes a subsidiary scanning direction along which the scanning module 500 moves to read an image, and the Y-axis denotes a main scanning direction along which the scanning module 500 reads an image line at a time.

The first flat glass panel 50 contacts a document when the document is moved into scanning position by the ADF 10, and the second flat glass panel 51 contacts the document (i.e., a recording medium, such as paper, transparency, etc.) when the document is stopped in position. The first and second flat glass panels 50 and 51 are separated from each other. A display panel 40 displays an operational state of the image reading apparatus and includes a plurality of control keys.

In the operational state of the image reading apparatus, a document stacked on a document feed tray 20 is moved to the first flat glass panel 50 by the ADF 10. The scanning module 500 located at the back of the first flat glass panel 50 reads an image from the document. After that, the document is discharged to a document output tray 30. A document guide member 70, having a sloped surface, is provided between ends of the first and second flat glass panels 50 and 51. The document guide member 70 guides a leading edge of the document to the document output tray 30 when the document passes the first flat glass panel 50.

Of course, it is understood that a document may also be directly placed on a top surface of the second flat glass panel 51 without being fed by the ADF 10. In this case, while moving in a scanning direction (hereinafter, in a positive direction of the X-axis) from the underside of the second flat glass panel 51, the scanning module 500 reads an image from the stopped document.

When reading an image from a document fed from the ADF 10, the scanning module 500 is stopped underneath the first flat glass panel 50, and when reading an image from a stopped document, the scanning module 500 is moved underneath the second flat glass panel 51. Of course, it is understood that the image reading apparatus, according to aspects of the present invention, is not limited to the image forming apparatus illustrated in FIG. 1. Various embodiments of the image reading apparatus may be used.

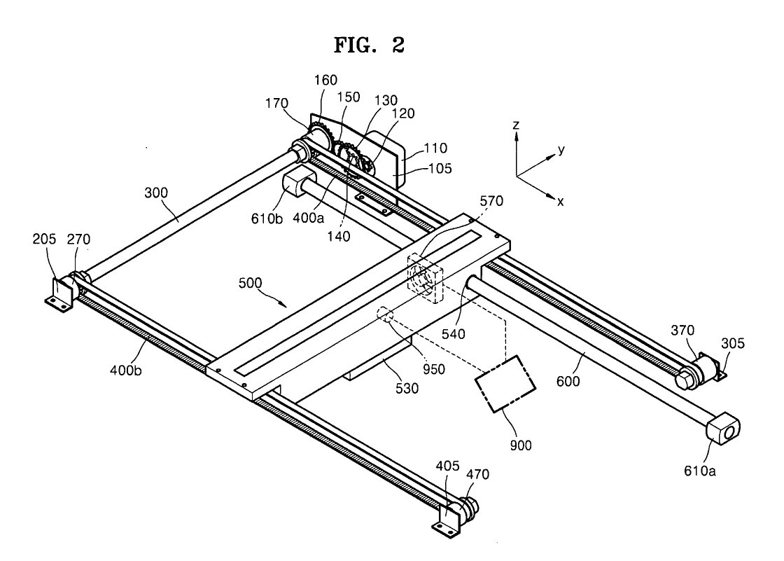

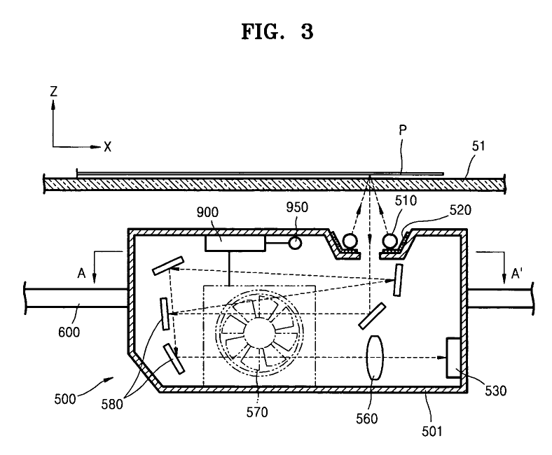

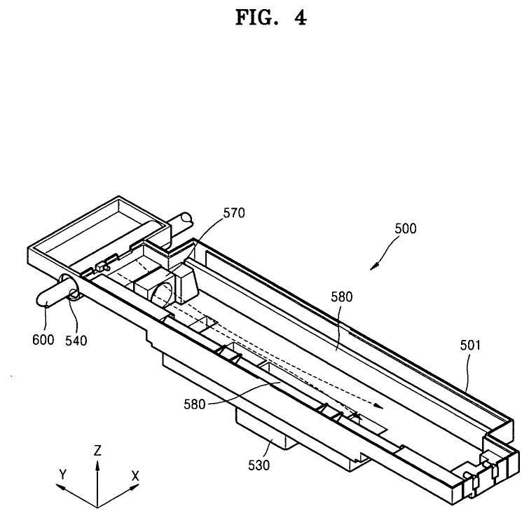

FIG. 2 is a perspective view of a scanning module and a driving module according to an embodiment of the present invention, FIG. 3 is a side-sectional view of the scanning module, and FIG. 4 is a cross-sectional perspective view taken along a line A-A′ of FIG. 3. As shown in FIGS. 2 through 4, the scanning module 500, as it slides, reads an image from a document (P), and a driving module moves the scanning module 500 in a subsidiary scanning direction.

As shown in FIG. 3, the scanning module 500 includes a light source 510 to project light to the document (P), a light reflecting member 520 to concentrate light radiated from the light source 510 toward the document (P), a lens unit 560 to focus an optical signal read from the document (P) onto an image sensor 530, a plurality of mirrors 580 to form an optical path from the light source 510 to the lens unit 560, the image sensor 530 to convert the optical signal focused by the lens unit 560 into an electrical signal, a frame 501 to form the outside of the scanning module 500, and a fan 570 (i.e., a blower fan) to move air inside the frame 501 so as to remove foreign substances from the inside of the frame 501 or so as to control the temperature inside the frame 501.

The image sensor 530 included in the scanning module 500 may be a charge coupled device (CCD) sensor that converts the optical signal read from the document into an electrical signal. In a high-rank image reading apparatus capable of reading an image from a document equal to or larger than A4 size, a CCD sensor may be used because of a high resolution thereof and relatively strong depth of focus.

With reference to FIG. 2, the driving module includes a guide hole 540 defined in the scanning module 500 and a guide shaft 600 inserted through the guide hole 540. The guide hole 540 allows the scanning module 500 to slide along the guide shaft 600 in the X-axis direction.

The scanning module 500, as it slides, vibrates depending on the gap size between the guide hole 540 and the guide shaft 600, a number of guide holes and guide shafts, if more than one of each is used, and the surface roughness of the guide shaft 600. Since the vibration of the scanning module 500 causes image reading errors, the driving module is designed to reduce the vibration.

In fact, a sliding bearing (not shown) may be fitted into the guide hole 540 to provide lubrication. Also a single guide shaft 600 may be provided at a position adjacent to a first timing belt 400a. Usually, however, the movement of the scanning module 500 is guided along a single shaft. This is due to the fact that, if two guide shafts 600 are used to guide both ends of the scanning module 500, vibration of the scanning module 500 may increase due to tolerance accumulation or other reasons. Both ends of the guide shaft 600 are fixed to a main body (not shown) of the image reading apparatus using shaft holders 610a and 610b. Though not shown, a sliding member is additionally provided on the main body of the image reading apparatus to support the weight of the scanning module 500 at both ends thereof. The sliding member is sufficiently lubricated to prevent a load from acting on the scanning module 500 in the sliding direction.

The driving module includes: the first timing belt 400a and a second timing belt 400b respectively coupled to both ends of the scanning module 500; a first belt pulley 170 and a second belt pulley 270, including teeth on outer surfaces thereof, to drive the first and second timing belts 400a and 400b, respectively; a connecting shaft 300 to coaxially couple the first and second belt pulleys 170 and 270, respectively, to each other; a driving motor 110; and a gear train to act as a power transmitting member connecting the driving motor 110 and the first belt pulley 170. The gear train may include a first gear 120 coaxially coupled to the driving motor 110, and second to fifth gears 130, 140, 150, 160 that are sequentially connected to the first gear 120. The gear train transmits driving power to the first pulley 170 at a reduced speed.

The first timing belt 400a and the first belt pulley 170, which drives the first timing belt 400a, and the second timing belt 400b and the second belt pulley 270, which drives the second timing belt 400b, are all respectively formed with teeth. This is advantageous because, as the size of the document (P) increases, the possibility of image reading errors increases since the size, weight, and sliding speed of the scanning module 500 increases in proportion to the increase of document size. The teeth of the first and second timing belts 400a and 400b mesh with the teeth of the first and second belt pulleys 170 and 270, respectively, to prevent such slippage. Since the first and second belt pulleys 170 and 270 are coaxially connected to each other by the connecting shaft 300, both ends of the scanning module 500 slide at the same speed.

Referring to FIG. 2, since driving power is transmitted directly to the scanning module 500 via the gear train, the first and second belt pulleys 170 and 270, the first and second timing belts 400a and 400b, and the connecting shaft 300, the position and speed of the scanning module 500 may be precisely controlled without an occurrence of slipping. In fact, the illustrated scanning module 500 may read an image from an A3 document (297 mm×420 mm) without an image reading error.

The driving module may further include a first bracket 105 to join the first belt pulley 170, the driving motor 110, and the gear train to the main body of the image reading apparatus, and a second bracket 205 to join the second belt pulley 270 to the main body.

A third belt pulley 370 is coupled to the other end of the first timing belt 400a, and a fourth belt pulley 470 is coupled to the other end of the second timing belt 400b. The third and fourth belt pulleys 370 and 470 are also formed with teeth on inner circumferences thereof. The third belt pulley 370 is coupled to the main body of the image reading apparatus by a third bracket 305, and the fourth belt pulley 470 is coupled to the main body by a fourth bracket 405.

As is described above, the scanning module 500, according to aspects of the present invention, includes the fan 570 (which may comprise, as noted above, a blower fan). Further, the image reading apparatus reads an image from the document (P) while moving the scanning module 500 with the fan 570 in the X-axis direction (the subsidiary scanning direction). The fan 570 circulates air inside the frame 501 in which the light source 510, the lens unit 560, the mirrors 580, and the image sensor 530 are mounted, and thereby eliminates foreign substances from the inside of the frame 501. The fan 570 also prevents the temperature of an inside of the frame 501 from rising, such that image reading errors due to thermal deformation may be reduced.

The fan 570 is disposed inside the frame 501 and blows air toward at least one of the light source 510, the mirrors 580, the lens unit 560, and the image sensor 530 that are provided in the frame 501 in order to remove foreign substances therefrom. The frame 501, the light source 510, the mirrors 580, and the lens unit 560 extend along the Y-axis (the main scanning direction), such that the fan 570 blows air in the main scanning direction. Since space inside the frame 501 is formed along the main scanning direction, the removal of foreign substances and the temperature control is efficiently performed by the blowing of air in the main scanning direction.

It is understood that additional fans 570 may be disposed along the main scanning direction of the frame 501. Such additional fans 570 would provide additional air blowing power along the longitudinal length of the frame 501 and thereby increase the degree to which foreign substances are cleaned from the light source 510, the mirrors 580, and the lens unit 560 in this case, a first fan 570 would be disposed at a first longitudinal end of the frame 501, as shown in FIG. 4, and the additional fans 570 would be placed at positions along the length of the frame 501 at which the blowing of air along the length of the frame 501 is maximized.

A control unit 900 is provided to control the operation of the fan 570. In the embodiment illustrated in FIG. 2, the control unit 900 is provided at an exterior of the scanning module 500, and, in the embodiment illustrated in FIG. 3, the control unit 900 is provided inside the scanning module 500. The control unit 900 supplies power to the fan 570 and controls the operation of the fan 570.

The control unit 900 may operate the fan 570 periodically when the scanning module 500 is in stand-by mode. In stand-by mode, the scanning module 500, as it prepares image reading, waits at a stand-by position for a scanning command. Though scanning is not performed in the stand-by mode, foreign substances can permeate the frame 501 through a gap tolerance of the frame 501, and can be accumulated on the mirrors 580 or the lens unit 560 if scanning module remains in the stand-by mode for a long time. Thus, the control unit 900 operates the fan 570 periodically to prevent caking of the foreign substances on the mirrors 580 or the lens unit 560.

When an air blowing command is input, the control unit 900 operates the fan 570. As is described above, since foreign substances, accumulated on the mirrors 580 or the lens unit 560, block light from passing from the light source 510 to the image sensor 530, the foreign substances are output as image data in the form of a black line according to the movement of the scanning module 500. If a black line that is inconsistent with original image data appears in an output of the image reading apparatus, a user may input the air blowing command via the display panel 40 or an external computer to remove the foreign substances by an operation of the fan 570. That is, the accumulation of foreign substances may be eliminated without the need for a service technician.

The scanning module 500 may further include a temperature sensor 950. The temperature sensor 950 senses the temperature of the inside of the frame 501. The control unit 900 may turn the fan 570 on and off according to the temperature measured by the temperature sensor 950. A reference temperature to prevent thermal deformations of the mirrors 580 and the lens unit 560 is previously stored in the control unit 900. If the temperature measured by the temperature sensor 950 is higher than the reference temperature, the control unit 900 operates the fan 570 to cool the inside of the frame 501.

For a normal operation of the scanning module 500, a method of conducting maintenance is required to remove foreign substances from the inside of the frame 501 or to prevent the temperature inside the frame 501 from rising excessively. In a method of conducting maintenance of the scanning module 500 according to an embodiment of the present invention, air is circulated in the frame 501 by the fan 570 to remove foreign substances attached to at least one of the light source 510, the lens unit 560, the mirrors 580, and the image sensor 530 that are installed in the frame 501 or to control the temperature inside the frame 501.

According to a method of maintaining the image reading apparatus according to the current embodiment of the present invention, when the scanning module 500 is in a stand-by mode, the fan may be periodically operated. Also, when an operation command is input, the fan 570 may be operated. Additionally, the temperature of the inside of the frame 501 may be measured by the temperature sensor 950, and the fan 570 may be turned on/off according to the measured temperature.

As is described above, according to aspects of the present invention, the scanning module, the image reading apparatus using the scanning module, and the maintenance method of the scanning module are designed such that foreign substances may be removed from the inside of the frame using the fan or the temperature inside the frame is prevented from rising, thereby preventing image reading errors due to the foreign substances or a rise in temperature. Thus maintenance time and cost may be reduced, thereby improving customer satisfaction.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A scanning module, comprising:
a light source to project light onto a document;
a lens unit to focus an optical signal read from the document being illuminated by the projected light;
a plurality of mirrors to form an optical path from the light source to the lens unit;
an image sensor to convert the optical signal focused by the lens unit into an electrical signal;
a frame to house the light source, the lens unit, the mirrors, and the image sensor; and
a fan to circulate air inside the frame.

2. The scanning module according to claim 1, wherein the fan blows the air in a main scanning direction of the scanning module.

3. An image reading apparatus in which a scanning module reads an image from a document while moving in a subsidiary scanning direction thereof, the scanning module comprising:
a light source to project light onto the document;
a lens unit to focus an optical signal read from the document being illuminated by the projected light;
a plurality of mirrors to form an optical path from the light source to the lens unit;
an image sensor to convert the optical signal focused by the lens unit into an electrical signal;
a frame to house the light source, the lens unit, the mirrors, and the image sensor; and
a fan circulating air inside the frame.

4. The image reading apparatus according to claim 3, wherein the fan blows the air in a main scanning direction of the scanning module.

5. The image reading apparatus according to claim 4, further comprising a control unit to operate the fan periodically when the scanning module is in a stand-by mode.

6. The image reading apparatus according to claim 4, further comprising a control unit to operate the fan when an operation command is input.

7. The image reading apparatus according to claim 4, further comprising:
a temperature sensor to measure a temperature of an interior of the frame; and
a control unit to turn the fan on and off according to the measured temperature.

8. A maintenance method of a scanning module provided with a frame and a light source, a lens unit, a mirror, and an image sensor that are mounted in the frame, the scanning module reading an image from a document while moving in a subsidiary scanning direction of the document, the maintenance method comprising circulating air inside the frame to remove foreign substances attached to at least one of the light source, the lens unit, the mirror, and the image sensor and/or to control a temperature of an interior of the frame.

9. The maintenance method according to claim 8, further comprising periodically circulating the air when the scanning module is in a stand-by mode.

10. The maintenance method according to claim 8, further comprising periodically circulating the air when an operation command is input.

11. The maintenance method according to claim 8, further comprising:
measuring a temperature of an interior of the frame; and
circulating the air according to the measured temperature.

12. An image reading apparatus in which a scanning module reads an image from a recording medium while moving in a subsidiary scanning direction thereof, the scanning module comprising:
a frame extending along a main scanning direction of the recording medium to house image reading components, the main scanning direction of the recording medium being transverse to the subsidiary scanning direction of the recording medium; and
an air circulating system to blow air along a longitudinal length of the frame.

13. The image reading apparatus according to claim 12, wherein the image reading components comprise:
a light source to project light onto the recording medium;
a lens unit to focus an optical signal read from the recording medium being illuminated by the projected light;
a plurality of mirrors to form an optical path from the light source to the lens unit; and
an image sensor to convert the optical signal focused by the lens unit into an electrical signal.

14. The image reading apparatus according to claim 12, wherein the air circulating system comprises at least one fan, the at least one fan being disposed at a longitudinal end of the frame to blow air along the longitudinal length of the frame.

15. The image reading apparatus according to claim 14, wherein the at least one fan blows the air in the main scanning direction of the scanning module.

16. The image reading apparatus according to claim 14, further comprising a control unit to operate the fan periodically when the scanning module is in a stand-by mode and/or to operate the fan when an operation command is input.

17. The image reading apparatus according to claim 14, further comprising:
a temperature sensor to measure a temperature of an interior of the frame; and
a control unit to turn the fan on and off according to the measured temperature.

18. A method of maintaining a scanning module provided with a frame and a light source, a lens unit, a mirror, and an image sensor that are mounted in the frame, the scanning module reading an image from a document while moving in a subsidiary scanning direction of the document, the maintenance method comprising circulating air inside the frame to clean the light source, the lens unit, the mirror, and the image sensor and/or to control a temperature of an interior of the frame.

19. The maintenance method according to claim 18, further comprising:
periodically circulating the air when the scanning module is in a stand-by mode; and
periodically circulating the air when an operation command is input.

20. The maintenance method according to claim 18, further comprising:
measuring a temperature of an interior of the frame; and
circulating the air according to the measured temperature.
